(19) United States
(12) Patent Application Publication
(10) Pub. No.: US 2012/0277449 A1
(43) Pub. Date: Nov. 1, 2012

(54) SYSTEMS AND METHODS FOR PRODUCING BIOFUELS FROM ALGAE

(76) Inventor: Gaye Elizabeth Morgenthaler, Woodside, CA (US)

(21) Appl. No.: 13/375,204

(22) PCT Filed: Jun. 4, 2010
(86) PCT No.: PCT/US2010/037354

§ 371 Date: Feb. 15, 2012

Related U.S. Application Data
(60) Provisional application No. 61/184,678, filed on Jun. 5, 2009.

(51) Int. Cl. C11B 1/00; A01K 61/02; A01K 63/00

(52) U.S. Cl. 554/8; 119/226; 119/51.04

(57) ABSTRACT

Provided herein are systems and methods for producing fish lipids and/or biofuels from algae that use nutrient-πch water derived from an upwelled water. The methods comprise harvesting the algae by a population of planktivorous organisms, such as fishes, gathering the planktivorous organisms, and extracting lipids from the organisms and/or polishing the lipids to form biofuel.

This application claims the benefit of U.S. Provisional Application No. 61/184,678, filed Jun. 5, 2009, which is incorporated by reference in its entirety.

### 1. INTRODUCTION

Provided herein are systems and methods for producing fish lipids and/or biofuels from algae.

### 2. BACKGROUND OF THE INVENTION

Algae have been considered as feedstock for producing biofuel, such as biodiesel. Some algae strains can produce up to 50% of their dried body weight in triglyceride oils. Algae do not need arable land and can be grown with impaired water, neither of which competes with terrestrial food crops. Moreover, the oil production per acre can be nearly 40 times that of a terrestrial crop, such as soybeans. Although algae present a feasible option for biofuel production, there is a need to reduce the cost of producing the biofuel from algae. The fall in oil price in late 2008 places an even greater pressure on the fledgling biofuel industry to develop inexpensive and efficient processes. Provided herein are economical and sustainable systems and methods for growing microalgae.

### 3. SUMMARY OF THE INVENTION

Provided herein are methods and systems for producing fish lipids and/or biofuels from algae grown in water enriched with nutrients that are normally inaccessible. In certain embodiments, the methods comprise providing an upwelling in a body of water, growing algae in the upwelled nutrient-rich water, and harvesting the algae by providing planktivorous organisms, such as a population of fish, that feed on the algae. Solar energy captured by photosynthesis in algae converts nutrients into algal biomass. As the fish harvest the algae, the energy in the algae is accumulated biologically as fish biomass. The methods provided herein further comprise gathering the fish, extracting lipids from the fish, and polishing the lipids to form biofuels. In certain embodiments, the extracted fish lipids are not limited to use as biofuels. In one embodiment, the extracted fish lipids can be used to obtain Omega-3 fatty acids, such as eicosapentaenoic acid (EPA) and/or docosahexaenoic acid (DHA) and/or derivatives thereof including, but not limited to esters, glycerides, phospholipids, sterols, and/or mixtures thereof.

### 4. DETAILED DESCRIPTION OF THE INVENTION

Culturing algae to produce biofuel requires steady and economical supplies of carbon (C), nitrogen (N), phosphorous (P), potassium (K), silicon (Si) and more than 50 minor nutrients, such as iron (Fe). The costs of supplying large amounts of C, N, P, and K to an algae culture can be a significant expense. The systems and methods provided herein reduce the cost of supplying C, N, P, and K to an algal culture by recovering the nutrients from deep waters that are normally inaccessible to algae growing near the surface.

The world's oceans comprise a plurality of stratified layers. According to water density, an ocean is divided into three horizontal depth zones: the mixed layer, pycnocline, and deep layer. Where a decline in temperature with depth is responsible for the increase in density with depth, the pycnocline is also a thermocline. On the other hand, if an increase in salinity is responsible for the increase in density with depth, the pycnocline is also a halocline. Typically, the pycnocline extends to a depth of 500 to 1000 m (1600 to 3300 ft). Water from different layers do not mix normally. However, the combination of persistent winds, Earth's rotation (the Coriolis effect), and restrictions on lateral movements of water caused by shorelines induces upward water movements. Coastal upwelling occurs where Ekman transport moves surface waters away from the coast; surface waters are replaced by water that wells up from below. Besides wind-driven upwelling, geostrophic currents also generate upwellings in the oceans.

The term “upwelling” as used herein refers to the upward directional movement of a mass of water from a source to a target within a body of water, such as but not limited to an ocean, an offshore area, a coastal area, or a lake. The source is characterized by its horizontal location (“source position”) and/or its vertical location (“source depth”) in the body of water. The position can be specified by its latitude and/or its longitude, or by its proximity to one or more oceanographic features. The target can be described similarly by its location (“target position”) and/or the depth of the target (“target depth”). Upwelling occurs where the depth of the source is greater than the depth of the target. The mass of water transferred from a source to a target of lesser depth is referred to as “upwelled water.”

In terms of exposure to sunlight, a body of water comprises a photic zone and an aphotic zone. The photic zone is the layer of water in a body of water, such as a lake or ocean, that is penetrated by sufficient sunlight for photosynthesis to occur. It extends from the surface downwards to a depth where light intensity falls to 1% of that at the surface. The thickness of the photic zone depends on the extent of light attenuation in the water column and is thus greatly affected by turbidity. The photic zone can be about a few centimeters in depth in turbid eutrophic lakes and up to about 200 meters in the open ocean. The aphotic zone is the layer of water beneath the photic zone which supports a minimum of photosynthetic activity, if any.

Primary production occurs predominantly in the photic zone where autotrophic organisms, such as microalgae, grow under sunlight and consume the nutrients in the photic zone. Heterotrophic organisms, e.g., zooplankton, feed on the autotrophic organisms, and the food web continues with the predation of phytoplankton and zooplankton by larger organisms, such as fishes, shellfishes, birds, and mammals. The particulate waste products produced by organisms in the photic zone and decaying bodies of dead organisms sink into and enrich deeper water in the aphotic zone. The water in the photic zone generally contains less nutrients than the water in the aphotic zone. Due to the paucity of mixing between surface water and denser water in the deep layer, many nutrients are deposited and accumulated near or at the bottom of a water column. Upwelled water derived from greater depth is thus richer with nutrients than surface water.

The nutrient profile of the water at a source is different from the nutrient profile of the water at a target before an episode of upwelling. The arrival of upwelled water from the source changes the nutrient profile at the target. In some embodiments, a nutrient profile comprises the concentration(s) of one or more of the following nutrients: C, N, P, K, Si, and/or minor nutrients, such as Fe, their organic and/or inorganic form, and their dissolved and/or particulate forms. In some embodiments, the profile can also be expressed in terms of the relative amounts of nutrients, such as a stoichiometric ratio. For example, it can correspond to the Redfield ratio for diatoms which is C:Si:N:P 106:15:16:1. In some embodiments, an upwelling of water from a greater depth increases the concentrations of C, N, P, K, Si, and/or minor nutrients, such as Fe, at a target near the surface. Many methods well known in the art can be used to determine the concentrations of nutrients in water.

In certain embodiments, the systems and methods provide culturing of planktivorous organisms in conjunction with an algal culture supported by upwelled nutrient-rich water, and harvesting the organisms to produce biofuel. In some embodiments, the systems and methods generate an upwelling of nutrient-rich water from a source to a target in a body of water that comprises a nutrient-rich source of water but where natural upwelling is negligible or non-existent. The availability of nutrients at an oligotrophic target site stimulates the rapid growth of algae, leading to an algal bloom. In some embodiments, the methods provided herein can further comprise maintaining the upwelling once it has been initiated. In certain embodiments, provided herein are systems and methods for controlling the upwelling to facilitate the growth of algae at a target site in a body of water that comprises an upwelling of a nutrient-rich source of water.

In certain embodiments, bodies of water useful in the systems and methods provided herein include, but are not limited to, oceans, seas, coasts, gulfs, bays, lakes, rivers, streams, wetlands, ponds, raceways, canals, and reservoirs. In some embodiments, bodies of water useful in the systems and methods provided herein include, but are not limited to, any bodies of water having waves, current, salinity, temperature gradient, salinity gradient, density gradient, or pressure gradient.

In some embodiments, the target site for an upwelling can correspond to the photic zone of a body of water. The target depth lies within the photic zone of a body of water, which can range from the surface to about 0.5, 1, 2, 5, 10, 20, 50, 100, 150, or 200 meters below the surface. In certain embodiments, the target site comprises an enclosure situated in a body of water, wherein the enclosure contains algae and fish. In some embodiments, the upwelling can be controlled so that the nutrient-rich water is directed to a target position and/or a target depth. In some embodiments, the upwelling can also be controlled to modify the supply rate of nutrients to the target site. In some embodiments, additional nutrients may be added, particularly nitrogen, which is in short supply in ocean waters. In some embodiments, sources of nitrogen include, but are not limited to, ammonium salts such as ammonium sulfate, ammonium chloride, ammonium nitrate, ammonium acetate, or alkali metal nitrates such as sodium or potassium nitrate, or ammonia, ammonium hydroxide, nitrates, nitrites, or urea. In some embodiments, sources of nitrogen is an organic sources of nitrogen, such as protein, protein hydrolysates, polypeptides, amino acids, corn steep liquor, beef or other meat extracts, soy protein products (e.g., isolates, flours, meals), yeast protein (e.g., yeast extracts, yeast autolysates), casein (hydrolyzed or unhydrolyzed), fishmeal, or other nitrogenous substances of plant or animal origin.

In some embodiments, the enclosures of the systems provided herein are connected by channels, hoses, and pipes. In some embodiments, the rate, direction, or both rate and direction of flow is controlled by pumps, valves, and gates.

In one aspect, the systems and methods provided herein pertain to the generation of and/or control of upwelling to stimulate growth of algae at a target site in a body of water. In certain embodiments, any methods and systems that can generate an upwelling in a body of water can be used. Many such methods known in the art exploit and manipulate the physical properties of water at or near, a source or a target, such as but not limited to density, salinity, and/or temperature of water. In some embodiments, other methods that can also be used are based on the action of mechanical/hydraulic/fluidic systems in water at or near a source or a target, or a current emanating from or near a source. Such methods can generate or control an upwelling by initiating, modifying, guiding, or deflecting a current. The direction of a current, the flow rate of a current, the fluid dynamics of a current (e.g., laminar or turbulent flow), or the path of a current can be modified. The division of a current into a plurality of currents, or the formation or cannibalization of eddies, are also contemplated. In some embodiments, any systems that can conduct or transfer a mass of nutrient-rich water from a source to a target, such as pipes, risers and pumps, can also be used. Exemplary means for generating and/or controlling upwelling are described in U.S. Pat. Nos. 3,683,627; 4,189,379; 4,231,312; 4,281,614; 4,597,360; 4,724,086; 5,106,230; 5,267,812; and 6,313,545, which are incorporated herein by reference each in its entirety.

In certain embodiments, the systems provided herein may comprise means for controlling an upwelling such as means to regulate the rate, direction, or both the rate and direction, of fluid flow between a source and a target, or at least one enclosure located at a target. In certain embodiments, the systems provided herein can comprise one or more devices including but not limited to devices powered by electricity, fossil fuel or biofuel, wind, wave, current, tide, hybrid devices powered by more than one power sources, and non-powered devices. In some embodiments, the devices can be mobile in the water, or stationary, such as being installed on the sea floor. In some embodiments, mobile devices can be driven or drifting, or tethered to a land-based anchor, a surface vessel, a submersible craft, an oil/gas platform, and/or the sea floor. In some embodiments, stationary devices can comprise moving and/or flexible parts. The buoyancy of mobile devices and parts of a stationary device can be controlled.

In one embodiment, the systems provided herein comprise any man-made devices that are present in or installed in a body of water to modify a flow of water, such that nutrient-rich water from a source is directed towards a target. Non-limiting examples of such man-made devices are mechanical objects that are installed or abandoned on the sea floor (also known as “hangs”), many of which become obstructions to shipping and oil/gas exploration. Such objects can be relocated to and/or aggregated at one or more locations on the sea floor to modify one or more currents in a body of water. Other man-made devices provided herein include but are not limited to network of pipelines, risers, and platforms that are installed for exploration and production of oil and/or natural gas and that can be modified for the purpose of certain embodiments by one of skill in the art. Examples of such oil and gas platform-based devices are described in U.S. provisional application No. 61/159,367, filed Mar. 11, 2009, which is incorporated herein by reference in its entirety.

In another aspect, the methods comprise providing one or more species of algae to a target site, such that the algae can consume the nutrients brought by an upwelling at the target site. In certain embodiments, without the upwelling, the water at a target site is oligotrophic and comprises mostly picoplankton and nanoplankton, such as Prochlorococcus and Synechococcus, that are in the size range of 0.2 to 2 micrometers. There are few planktivorous fish that can efficiently filter plankton in this size range. Other algae are only present at a low level at the target site and may take a period of time to expand in numbers. In certain embodiments, the algae are selected according to their abilities to assimilate efficiently the nutrients transferred by an upwelling to the target site, taking into account the nutrient profile of the site over a period of time. In certain embodiments, the algae are also selected according to their suitability as food for the planktivorous organisms provided herein for harvesting. For example, it is desirable that the size of the algae matches the filter-feeding abilities of the plantivorous organisms.

A limiting nutrient is a nutrient that dictates, at least in part, the growth rate of one or more groups of organisms, such as bacterioplankton and/or phytoplankton, at a site or in a body of water. Depending on their initial concentrations, one or more of the other nutrients, such as C, N, P, K, Si, and Fe, can become depleted as they are consumed by growing organisms. Since different organisms have different nutrient requirements and growth rates, it is expected that a nutrient can be depleted and become limiting for certain groups of organisms and not limiting for others. Such a condition can select for organisms that are less dependent on the depleted nutrient. Organisms experiencing nutrient limitation is at a growth disadvantage relative to other organisms. For example, nitrogen-fixing organisms, such as certain cyanobacteria, are favorably selected in a body of water that is nitrogen-limited. Silicon is required for the growth of diatoms. In certain embodiments, as limiting nutrients affect significantly the primary and secondary productivities of a body of water, the systems and methods provide upwelled water and/or added nutrients to prevent or overcome nutrient limitation at a target site, and/or to steer the growth of a population of algae so that algal species that are preferably consumed by the planktivorous organisms provided herein become the major species in the growing population. Nutrients that can be added to the target site include macronutrients such as C, N, P, K, Si, and micronutrients, such as inorganic salts including but not limited to Fe, Ca, Zn, Mn, B, Mo, Mg, V, Sr, Al, Rb, Li, Cu, Co, Br, I, and Se.

As used herein the term “algae” refers to any organisms with chlorophyll and a thallus not differentiated into roots, stems and leaves, and encompasses prokaryotic and eukaryotic organisms that are photoautotrophic or photoauxotrophic. The term “algae” includes macroalgae (commonly known as seaweed or kelp) and microalgae. For certain embodiments, algae that are not macroalgae are preferred. The terms “microalgae” and “phytoplankton,” used interchangeably herein, refer to any microscopic algae, photoautotrophic or photoauxotrophic protozoa, photoautotrophic or photoauxotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that includes algae, and is not limited to the body of water or the culture in which the algae are cultivated. An “algal culture” is an algal composition that includes live algae.

The microalgae provided herein are also encompassed by the term “plankton” which includes phytoplankton, zooplankton and bacterioplankton. The systems and methods provided herein can be used with a composition comprising plankton, or a body of water comprising plankton. A mixed algal composition used in certain embodiments provided herein comprises one or several dominant species of macroalgae and/or microalgae. Microalgal species can be identified by microscopy and enumerated by counting, microfluidics, or flow cytometry, which are techniques well known in the art. A dominant species is one that ranks high in the number of algal cells, e.g., the top one to five species with the highest number of cells relative to other species. In various embodiments, one, two, three, four, or five dominant species of algae are present in an algal composition.

In yet another aspect, the systems and methods comprise providing one or more species of planktivorous organisms to a target site, such that the planktivorous organisms can consume the algae that are growing due to the nutrients brought by an upwelling at the target site. Non-limiting examples of planktivorous organisms include fishes, shellfishes (e.g., bivalves and gastropods), crustaceans (e.g., brine shrimps, hills), and zooplankton (e.g., copepods, cladocerans, and tunicates). In one embodiment, the algae can be harvested with planktivorous, herbivorous, or omnivorous fishes of the order Clupeiformes, Siluriformes, Cypriniformes, Mugiliformes, and/or Perciformes. Preferably, at least one planktivorous species of fish in the order Clupeiformes is used. Non-limiting examples of useful fishes include menhadens, shads, herrings, sardines, hilsas, anchovies, catfishes, carps, milkfishes, shiners, paddlefish, and/or minnows. Gut content analysis can determine the diet of a fish provided herein. Techniques for analysis of gut content of fish are known in the art. The choice of fish for use in the harvesting methods provided herein depends on a number of factors, such as the palatability and nutritional value of the cultured algae as food for the fishes, the lipid composition and content of the fish, the feed conversion ratio, the fish growth rate, and the environmental requirements that encourage feeding and growth of the fish.

One or more species of fish can be used to harvest the algae from an algal composition. In certain embodiments, a fish population is mixed and thus comprises one or several major species of fish. A major species is one that ranks high in the head count, e.g., the top one to five species with the highest head count relative to other species. The methods provided herein can employ such species of fishes that are otherwise used as human food, animal feed, or oleochemical feedstocks, for making biofuel. In some embodiments, depending on the economics of operating an algal culture facility, some of the fishes used in the present method can be sold as human food, animal feed or oleochemical feedstock. Stocks of fish provided herein can be obtained initially from fish hatcheries or collected from the wild. In a preferred embodiment, cultured fishes are used. The fishes may be fish fry, juveniles, fingerlings, or adult/mature fish. In certain embodiments, fry and/or juveniles that have metamorphosed are used. Any fish aquaculture techniques known in the art can be used to stock, maintain, reproduce, and gather the fishes provided herein.

In addition to means for generating or controlling upwelling, the systems provided herein can comprise at least one enclosure containing fish, means for gathering the fish, means for extracting lipids from the fishes, and means for converting the lipids into biofuels or other useful products. The term “enclosure” refers to a water-containing enclosure in which algae are cultured and harvested by fish. In some embodiments, the enclosures provided herein can be but are not limited to tanks, cages, and/or net-pens. A cage can be submerged, submersible or floating in a body of water, such as a lake, a bay, an estuary, or the ocean. In certain embodiments, in addition to algae and fishes, the enclosures provided herein may comprise one or more additional aquatic life forms, such as but not limited to bacteria, zooplankton, aquatic plants, crustaceans (cladocera and copepoda), insects, worms, nematodes, and mollusks.

In certain embodiments, the systems provided herein further comprise means for connecting the enclosures to each other, to other parts of the system and to water sources and points of disposal. The connecting means facilitates fluid flow, temporarily or permanently, and can include but is not limited to a network of channels, hoses, conduits, viaducts, and pipes. In some embodiments, the systems further comprise means for regulating the rate, direction, or both the rate and direction, of fluid flow throughout the network, such as flow between the enclosures and other parts of the system. The flow regulating means can include but is not limited to pumps, valves, manifolds, and gates. In some embodiments, the systems provided herein also provide means to monitor and regulate the environment of a target site and/or the enclosures, which include but is not limited to means to monitor and/or adjust the pH, salinity, dissolved oxygen, temperature, turbidity, concentrations of nutrients, especially macronutrients such as C, N, P, K, Si, and micronutrients (e.g., Fe, Zn, Ca, Mn, B, Mo, Mg, V, Sr, Al, Rb, Li, Cu, Co, Br, I, and Se) and other aquatic conditions. Any fish processing technologies and means known in the art can be applied to obtain lipids, proteins, and hydrocarbons from the fishes. Exemplary systems and methods of using fish to harvest algae for the production of biofuel are described in U.S. provisional application No. 61/099,503, filed Sep. 23, 2008, which is incorporated herein by reference its entirety.

In certain embodiments, the systems and methods provided herein can be practiced in many parts of the world, such as but not limited to the coasts, the contiguous zones, the territorial zones, and the exclusive economic zones of the United States. In some embodiments, a system provided herein can be established at the coasts of Gulf of Mexico, or in the waters of the Gulf of Mexico basin, Northeast Gulf of Mexico, South Florida Continental Shelf and Slope, Campeche Bank, Bay of Campeche, Western Gulf of Mexico, and Northwest Gulf of Mexico. Naturally occurring upwellings are located at outer margins of the wide continental shelves of Yucatan and Florida peninsulas.

In certain embodiments, provided herein are a biofuel feedstock or a biofuel comprising lipids, hydrocarbons, or both, derived from fish that harvested algae according to the methods provided herein. Lipids obtained by the systems and methods provided herein can be subdivided according to polarity: neutral lipids and polar lipids. The major neutral lipids are triglycerides, and free saturated and unsaturated fatty acids. The major polar lipids are acyl lipids, such as glycolipids and phospholipids. The hydrocarbons obtained by the systems and methods provided herein include, but are not limited to, isoprenoids, or pigments such as chlorophyll, carotenoids (e.g., carotene, lycopene, lutein), astaxanthin, melanin, anthocyanins, porphyrins, tetraterpenoids, and betalains. A composition comprising lipids and hydrocarbons obtained by the systems and methods provided herein can be described and distinguished by the types and relative amounts of key fatty acids and/or hydrocarbons present in the composition.

Fatty acids are identified herein by a first number that indicates the number of carbon atoms, and a second number that is the number of double bonds, with the option of indicating the position of the first double bond or the double bonds in parenthesis. The carboxylic group is carbon atom 1 and the position of the double bond is specified by the lower numbered carbon atom. For example, linoleic acid can be identified by 18:2 (9, 12).

In certain embodiments, fatty acids produced by the cultured algae provided herein comprise one or more of the following: 12:0, 14:0, 14:1, 15:0, 16:0, 16:1, 16:2, 16:3, 16:4, 17:0, 18:0, 18:1, 18:2, 18:3, 18:4, 19:0, 20:0, 20:1, 20:2, 20:3, 20:4, 20:5, 22:0, 22:5, 22:6, and 28:1 and in particular, 18:1(9), 18:2(9, 12), 18:3(6, 9, 12), 18:3(9, 12, 15), 18:4(6, 9, 12, 15), 18:5(3, 6, 9, 12, 15), 20:3(8, 11, 14), 20:4(5, 8, 11, 14), 20:5(5, 8, 11, 14, 17), 20:5(4, 7, 10, 13, 16), 20:5(7, 10, 13, 16, 19), 22:5(7, 10, 13, 16, 19), 22:6(4, 7, 10, 13, 16, 19). Without limitation, it is expected that many of these fatty acids are present in the lipids extracted from the fishes that ingested the cultured algae. Algae produce mostly even-numbered straight chain saturated fatty acids (e.g., 12:0, 14:0, 16:0, 18:0, 20:0 and 22:0) with smaller amounts of odd-numbered acids (e.g., 13:0, 15:0, 17:0, 19:0, and 21:0), and some branched chain (iso- and anteiso-) fatty acids. A great variety of unsaturated or polyunsaturated fatty acids are produced by algae, mostly with C₁₂ to C₂₂ carbon chains and 1 to 6 double bonds, mainly in cis configurations.

The hydrocarbons present in algae are mostly straight chain alkanes and alkenes, and may include paraffins and the like having up to 36 carbon atoms. The hydrocarbons are identified by the same system of naming carbon atoms and double bonds as described above for fatty acids. Non-limiting examples of the hydrocarbons are 8:0, 9,0, 10:0, 11:0, 12:0, 13:0, 14:0, 15:0, 15:1, 15:2, 17:0, 18:0, 19:0, 20:0, 21:0, 21:6, 23:0, 24:0, 27:0, 27:2(1, 18), 29:0, 29:2(1, 20), 31:2(1, 22), 34:1, and 36:0.

In certain embodiments, a great variety of unsaturated or polyunsaturated fatty acids are produced by fish mostly with C₁₂ to C₂₂ carbon chains and 1 to 6 double bonds, mainly in cis configurations (Stansby, M. E., “Fish oils,” The Avi Publishing Company, Westport, Conn., 1967). Fish oil comprises about 90% triglycerides, about 5-10% monoglycerides and diglycerides, and about 1-2% sterols, glyceryl ethers, hydrocarbons, and fatty alcohols. One of skill would understand that the amount and variety of lipids in fish oil varies from one fish species to another, and also with the season of the year, the algae diet, spawning state, and environmental conditions. Fatty acids produced by the fishes provided herein comprise, without limitation, one or more of the following: 12:0, 14:0, 14:1, 15:branched, 15:0, 16:0, 16:1, 16:2 n−7, 16:2 n−4, 16:3 n−4, 16:3 n−3, 16:4 n−4, 16:4 n−1, 17:branched, 17:0, 17:1, 18:branched, 18:0, 18:1, 18:2 n−9, 18:2 n−6, 18:2 n−4, 18:3 n−6, 18:3 n−6, 18:3 n−3, 18:4 n−3, 19:branched, 19:0, 19:1, 20:0, 20:1, 20:2 n−9, 20:2 n−6, 20:3 n−6, 20:3 n−3, 20:4 n−6, 20:4 n−3, 20:5 n−3, 21:0, 21:5 n−2, 22:0, 22:1 n−11, 22:2, 22:3 n−3, 22:4 n−3, 22:5 n−3, 22:6 n−3, 23:0, 24:0, 24:1 (where n is the first double bond counted from the methyl group). See, also Jean Guillaume, Sadisivam Kaushik, Pierre Bergot, and Robert Metailler, “Nutrition and Feeding of Fish and Crustaceans,” Springer-Praxis, UK, 2001).

In certain embodiments, provided herein are methods of making a liquid fuel which comprise processing lipids derived from fish that harvested algae. Products provided herein made by the processing of fish-derived biofuel feedstocks can be incorporated or used in a variety of liquid fuels including but not limited to, diesel, biodiesel, green diesel, kerosene, jet-fuel, gasoline, JP-1, JP-4, JP-5, JP-6, JP-7, JP-8, Jet Propellant Thermally Stable (JPTS), Fischer-Tropsch liquids, alcohol-based fuels including ethanol-containing transportation fuels, and other biomass-based liquid fuels including cellulosic biomass-based transportation fuels.

In certain embodiments, triacylglycerides in fish oil can be converted to fatty acid methyl esters (FAME or biodiesel), for example, by using a base-catalyzed transesteritication process (for an overview see, e.g., K. Shaine Tyson, Joseph Bozell, Robert Wallace, Eugene Petersen, and Luc Moens, “Biomass Oil Analysis: Research Needs and Recommendations, NREL/TP-510-34796, June 2004). The triacylglycerides are reacted with methanol in the presence of NaOH at 60° C. for 2 hrs to generate a fatty acid methyl ester (biodiesel) and glycerol.

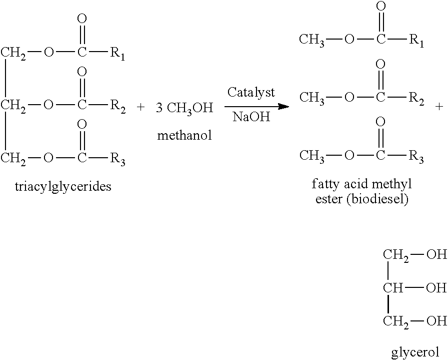

The biodiesel and glycerol co-products are immiscible and typically separated downstream through decanting or centrifugation, followed by washing and purification. Free fatty acids (FFAs) are a natural hydrolysis product of triglyceride and formed by the following reaction with triacylglycerides and water:

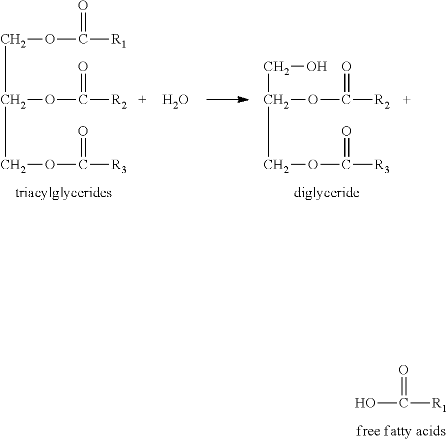

In some embodiments, this side reaction is undesirable because free fatty acids convert to soap in the transesterification reaction, which then emulsifies the co-products, glycerol and biodiesel, into a single phase. Separation of this emulsion becomes extremely difficult and time-consuming without additional cost-prohibitive purification steps.

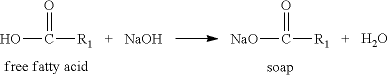

In certain embodiments, the methods provided herein can further comprise a step for quickly and substantially drying the fish oil by techniques known in the art to limit production of free fatty acids, preferably to less than 1%. In another embodiment, the methods provided herein can further comprise a step for converting or removing the free fatty acids by techniques known in the art.

In certain embodiments, triacylglycerides in fish oil can also be converted to fatty acid methyl esters (FAME or biodiesel) by acid-catalyzed transesterification, enzyme-catalyzed transesterification, or supercritical methanol transesterification. Supercritical methanol transesterification does not require a catalyst (Kusdiana, D. and Saka, S., “Effects of water on biodiesel fuel production by supercritical methanol treatment,” Bioresource Technology 91 (2004), 289-295; Kusdiana, D. and Saka, S., “Kinetics of transesterification in rapeseed oil to biodiesel fuel as treated in supercritical methanol,” Fuel 80 (2001), 693-698; Saka, S., and Kusdiana, D., “Biodiesel fuel from rapeseed oil as prepared in supercritical methanol,” Fuel 80 (2001), 225-231). The reaction in supercritical methanol reduces the reaction time from 2 hrs to 5 minutes. In addition, the absence of the base catalyst NaOH greatly simplifies the downstream purification, reduces raw material cost, and eliminates the problem with soaps from free fatty acids. Rather than being a problem, the free fatty acids become valuable feedstocks that are converted to biodiesel in the supercritical methanol as follows.

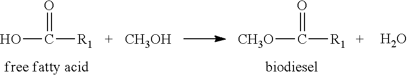

Non-limiting exemplary reaction conditions for both the base-catalyzed and supercritical methanol methods are shown in Table 1 below. As will be apparent to one of ordinary skill in the art, other effective reaction conditions can be applied with routine experimentation to convert the triacylglycerides in fish oil to biodiesel by either one of these methods.

TABLE 1
Comparison between base-catalyzed and supercritical processing

| | Traditional Method | SC Methanol |
|---|---|---|
| Reaction time | 2 hrs | <5 min |
| Conditions | Atmospheric, 60° C. | 1,000 psig, 350° C. |
| Catalyst | NaOH | None |
| FFA product | Soap | Biodiesel |
| Acceptable Water (%) | <1% | No limit |

In another embodiment, triacylglycerides are reduced with hydrogen to produce paraffins, propane, carbon dioxide and water, a product generally known as green diesel. The paraffins can either be isomerized to produce diesel or blended directly with diesel. The primary advantages of hydrogenation over conventional base-catalyzed transesterification are two-fold. First, the hydrogenation process is thermochemical and therefore much more robust to feed impurities as compared to biochemical processes, i.e., hydrogenation is relatively insensitive to free fatty acids and water. Free fatty acids are readily converted to paraffins, and water simply reduces the overall thermal efficiency of the process but does not significantly alter the chemistry. Second, the paraffin product is a pure hydrocarbon, and therefore indistinguishable from petroleum-based hydrocarbons. Unlike biodiesel which has a 15% lower energy content and can freeze in cold weather, green diesel has similar energy content and flow characteristics (e.g., viscosity) to petroleum-based diesel. In some embodiments, the methods provided herein encompass the steps of hydrogenation and isomerization, which are well known in the art to produce liquid fuels, such as jet-fuel, diesel, kerosene, gasoline, JP-1, JP-4, JP-5, JP-6, JP-7, JP-8, and JPTS.

In yet another embodiment, residual fish biomass, such as fishmeal, that remains after the extraction of lipids are used as a feedstock to produce biofuel. Residual fish biomass can be upgraded to bio-oil liquids, a multi-component mixture through fast pyrolysis (for an overview see, e.g., S. Czernik and A. V. Bridgwater, “Overview of Applications of Biomass Fast Pyrolysis Oil,” Energy & Fuels 2004, 18, pp. 590-598; A. V. Bridgwater, “Biomass Fast Pyrolysis,” Thermal Science 2004, 8(8), pp. 21-29); Oasmaa and S. Czemik, “Fuel Oil Quality of Biomass Pyrolysis Oils—State of the Art for End Users,” Energy & Fuels, 1999, 13, 914-921; D. Chiaramonti, A. Oasmaa, and Y. Solantausta, “Power Generation Using Fast Pyrolysis Liquids from Biomass, Renewable and Sustainable Energy Reviews, August 2007, 11(6), pp. 1056-1086). According to certain embodiments provided herein, residual fish biomass is rapidly heated to a temperature of about 500° C., and thermally decomposed to 70-80% liquids and 20-30% char and gases. The liquids, pyrolysis oils, can be upgraded by hydroprocessing to make products, such as naphtha and olefins. Those skilled in the art will know many other suitable reaction conditions, or will be able to ascertain the same by use of routine experimentation.

In yet another embodiment, residual fish biomass can be subjected to gasification which partially oxidizes the biomass in air or oxygen to form a mixture of carbon monoxide and hydrogen or syngas. The syngas can be used for a variety of purposes, such as but not limited to, generation of electricity or heat by burning, Fischer-Tropsch synthesis, and manufacture of organic compounds. For an overview of syngas, see, e.g., Spath, P. L., and Dayton, D. C., “Preliminary Screening—Technical and Economic Assessment of Synthesis Gas to Fuels and Chemicals with Emphasis on the Potential for Biomass-derived Syngas.” NREL/TP-510-34929, December 2003.

In yet another embodiment, residual fish biomass can be subjected to fermentation to convert carbohydrates to ethanol which can be separated using standard techniques. Numerous fungal and bacterial fermentation technologies are known in the art and can be used in accordance with certain embodiments provided herein. For an overview of fermentation, see, e.g., Edgard Gnansounou and Arnaud Dauriat, “Ethanol fuel from biomass: A Review,” Journal of Scientific and Industrial Research, Vol. 64, November 2005, pp 809-821.

In certain embodiments, the processing step involves heating the fishes to greater than about 70° C., 80° C., 90° C. or 100° C., typically by a steam cooker, which coagulates the protein, ruptures the fat deposits and liberates lipids and oil and physico-chemically bound water, and; grinding, pureeing and/or pressing the fish by a continuous press with rotating helical screws. The fishes can be subjected to gentle pressure cooking and pressing which use significantly less energy than that required to obtain lipids from algae. The coagulate may alternatively be centrifuged. This step removes a large fraction of the liquids (press liquor) from the mass, which comprises an oily phase and an aqueous fraction (stickwater). The separation of press liquor can be carried out by centrifugation after the liquor has been heated to 90° C. to 95° C. Separation of stickwater from oil can be carried out in vertical disc centrifuges. In some embodiments, the lipids in the oily phase (fish oil) may be polished by treating with hot water, which extracts impurities from the lipids to form biofuel. To obtain fishmeal, the separated water is evaporated to form a concentrate (fish solubles), which is combined with the solid residues, and then dried to solid form (presscake). The dried material may be ground to a desired particle size. The fishmeal typically comprises mostly proteins (up to 70%), ash, salt, carbohydrates, and oil (about 5-10%). The fishmeal can be used as animal feed and/or as an alternative energy feedstock.

In another embodiment, the fishmeal is subjected to a hydrothermal process that extracts residual lipids, both neutral and polar. A large proportion of polar lipids, such as phospholipids, remain with the fishmeal and lost as biofuel feedstock. Conversion of such polar lipids into fatty acids can boost the overall yield of biofuel from fish. The hydrothermal process provided herein generally comprises treating fishmeal with near-critical or supercritical water under conditions that can extract polar lipids from the fishmeal and/or hydrolyze polar lipids resulting in fatty acids. The fishmeal need not be dried as the moisture in the fishmeal can be used in the process. The process comprises applying pressure to the fish to a predefined pressure and heating the fishmeal to a predefined temperature, wherein lipids in the fishmeal are extracted and/or hydrolyzed to form fatty acids. The fishmeal can be held at one or more of the preselected temperature(s) and preselected pressure(s) for an amount of time that facilitates, and preferably maximizes, hydrolysis and/or extraction of various types of lipids. The term “subcritical” or “near-critical water” refers to water that is pressurized above atmospheric pressure at a temperature between the boiling temperature (100° C. at 1 atm) and critical temperature (374° C.) of water. The term “supercritical water” refers to water above its critical pressure (218 atm) at a temperature above the critical temperature (374° C.). In some embodiments, the predefined pressure is between 5 atm and 500 atm. In some embodiments, the predefined temperature is between 100° C. and 500° C. or between 325° C. and 425° C. The reaction time can range between 5 seconds and 60 minutes. For example, a fishmeal can be exposed to a process condition comprising a temperature of about 300° C. at about 80 atm for about 10 minutes. The selection of an appropriate set of process conditions, i.e., combinations of temperature, pressure, and process time can be determined by assaying the quantity and quality of lipids and free fatty acids, e.g., neutral lipids, phospholipids and free fatty acids, that are produced. The process further comprises separating the treated fishmeal into an organic phase which includes the lipids and/or fatty acids, an aqueous phase, and a solid phase; and collecting the organic phase as biofuel or feedstock.

In some embodiments, the systems provided herein can comprise, independently and optionally, means for gathering fishes from which lipids are extracted (e.g., nets), means for conveying the gathered fishes from the fish enclosure or a holding enclosure to the fish processing facility (e.g., pipes, conveyors, bins, trucks), means for cutting large pieces of fish into small pieces before cooking and pressing (e.g., chopper, hogger), means for heating the fishes to about 70° C., 80° C., 90° C. or 100° C. (e.g., steam cooker); means for grinding, pureeing, and/or pressing the fishes to obtain lipids (e.g., single screw press, twin screw press, with capacity of about 1-20 tons per hour); means for separating lipids from the coagulate (e.g., decanters and/or centrifuges); means for separating the oily phase from the aqueous fraction (e.g., decanters and/or centrifuges); and means for polishing the lipids (e.g., reactor for transesterification or hydrogenation). Many commercially available systems for producing fishmeal can be adapted for use in certain embodiments, including stationary and mobile systems that are mounted on a container frame or a flat rack. The fish oil or a composition comprising fish lipids, can be collected and used as a biofuel, or upgraded to biodiesel or other forms of energy feedstock. For example, biodiesel can be produced by transesterification of the fish lipids, and green diesel by hydrogenation, using technology well known to those of skill in the art.

In certain embodiments, the extracted fish lipids are not limited to use as biofuels. In one embodiment, the extracted fish lipids can be used to obtain Omega-3 fatty acids, such as eicosapentaenoic acid (EPA) and/or docosahexaenoic acid (DHA) and/or derivatives thereof including, but not limited to esters, glycerides, phospholipids, sterols, and/or mixtures thereof. In one embodiment, the extracted fish lipids contain substantially purified EPA and/or DHA ranging from 1 to 50%, depending on the fish species, age, location, and a host of ecological and environmental factors. If higher EPA and/or DHA concentrations are desired, several established methods could be employed, including chromatography, fractional or molecular distillation, enzymatic splitting, low-temperature crystallization, supercritical fluid extraction, or urea complexation. These methods can further concentrate the EPA and/or DHA to nearly pure EPA and/or DHA.

In certain embodiments, EPA- and/or DHA-containing lipids may be separated and concentrated by short-path distillation, or molecular distillation. The lipids are first transesterified, either acid- or base-catalyzed, with ethanol to produce a mixture of fatty acid ethyl esters (FAEE). The FAEE are then fractionated in the short-path distillation to remove the short chain FAEE, C-14 to C-18. The concentrate of FAEE from C-20 to C-22 is where the EPA and/or DHA can be found. A second distillation of the concentrate can result in a final Omega-3 content of up to 70%. The concentration of the EPA and/or DHA in the final product will depend on the initial lipid profile of the fish oil. The FAEE can be used as a consumer product at this stage (fish oil capsules). In some countries, the FAEE are required to be reconverted to triglycerides through a glycerolysis reaction before they can be sold as a consumer product. In order to obtain pure EPA and/or DHA, an additional purification step is required using chromatography, enzymatic transesterification, ammonia complexation, or supercritical fluid extraction.

In certain embodiments, the systems and methods provide an EPA and/or DMA feedstock or an EPA and/or DHA comprising lipids, hydrocarbons, or both, derived from fish that harvested algae according to the methods provided herein. Lipids of the present embodiments can be subdivided according to polarity: neutral lipids and polar lipids. The major neutral lipids are triglycerides, and free saturated and unsaturated fatty acids. The major polar lipids are acyl lipids, such as glycolipids and phospholipids. The hydrocarbons obtained by the systems and methods provided herein include, but are not limited to, isoprenoids, or pigments such as chlorophyll, carotenoids (e.g., carotene, lycopene, lutein), astaxanthin, melanin, anthocyanins, porphyrins, tetraterpenoids, and betalains. A composition comprising lipids and hydrocarbons of the present embodiments can be described and distinguished by the types and relative amounts of key fatty acids and/or hydrocarbons present in the composition.

Fatty acids are identified herein by a first number that indicates the number of carbon atoms, and a second number that is the number of double bonds, with the option of indicating the position of the first double bond or the double bonds in parenthesis. The carboxylic group is carbon atom 1 and the position of the double bond is specified by the lower numbered carbon atom. For example, EPA is identified as 20:5 (n−3), which is all-cis-5,8,11,14,17-eicosapentaenoic acid, and DHA is identified as 22:6 (n−3), which is all-cis-4,7,10,13,16,19-docosahexaenoic acid, or DHA. The n−3 designates the location of the double bond, counting from the end carbon (highest number).

In certain embodiments, EPA and/or DHA in the predominant form of triglyceride esters can be converted to lower alkyl esters, such as methyl, ethyl, or propyl esters, by known methods and used in an esterification with a sterol to form esters, which can be further purified for use as nutritional supplement. Transesterification, in general, is well known in the art. See, e.g., W. W. Christie, “Preparation of Ester Derivatives of Fatty Acids for Chromatographic Analysis,” Advances in Lipid Methodology—Volume Two, Ch. 2, pp. 70-82 (W. W. Christie, ed., The Oily Press, Dundee, United Kingdom, 1993).

In certain embodiments, to obtain a refined product with higher concentrations of EPA and/or DHA, certain lipases can be used to selectively transesterify the ester moieties of EPA and/or DHA in fish oil triglycerides, under substantially anhydrous reaction conditions, as described in U.S. Pat. No. 5,945,318.

In certain embodiments, one or more edible additives can be included for consumption with the nutritional supplement of containing EPA and/or DHA. In one embodiment, additives can include one or more antioxidants, such as, vitamin C, vitamin E or rosemary extract. In one embodiment, additives can include one or more suitable dispersant, such as, lecithin, an alkyl polyglycoside, polysorbate 80 or sodium lauryl sulfate. In one embodiment, additives can include a suitable antimicrobial such as, for example, sodium sulfite or sodium benzoate. In one embodiment, additives can include one or more suitable solubilizing agent, such as, a vegetable oil such as sunflower oil, coconut oil, and the like, or mono-, di- or tri-glycerides.

In certain embodiments, additives can include, but are not limited to, vitamins such as vitamin A (retinol, retinyl palmitate or retinol acetate), vitamin B1 (thiamin, thiamin hydrochloride or thiamin mononitrate), vitamin B2 (riboflavin), vitamin B3 (niacin, nicotinic acid or niacinamide), vitamin B5 (pantothenic acid, calcium pantothenate, d-panthenol or d-calcium pantothenate), vitamin B6 (pyridoxine, pyridoxal, pyridoxamine or pyridoxine hydrochloride), vitamin B12 (cobalamin or cyanocobalamin), folic acid, folate, folacin, vitamin H (biotin), vitamin C (ascorbic acid, sodium ascorbate, calcium ascorbate or ascorbyl palmitate), vitamin D (cholecalciferol, calciferol or ergocalciferol), vitamin E (d-alpha-tocopherol, or d-alpha tocopheryl acetate) or vitamin K (phylloquinone or phytonadione).

In certain embodiments, additives can include, but are not limited to, minerals such as boron (sodium tetraborate decahydrate), calcium (calcium carbonate, calcium caseinate, calcium citrate, calcium gluconate, calcium lactate, calcium phosphate, dibasic calcium phosphate or tribasic calcium phosphate), chromium (GTF chromium from yeast, chromium acetate, chromium chloride, chromium trichloride and chromium picolinate) copper (copper gluconate or copper sulfate), fluorine (fluoride and calcium fluoride), iodine (potassium iodide), iron (ferrous fumarate, ferrous gluconate gluconate, magnesium hydroxide or magnesium oxide), manganese (manganese gluconate and manganese sulfate), molybdenum (sodium molybdate), phosphorus (dibasic calcium phosphate, sodium phosphate), potassium (potassium aspartate, potassium citrate, potassium chloride or potassium gluconate), selenium (sodium selenite or selenium from yeast), silicon (sodium metasilicate), sodium (sodium chloride), strontium, vanadium (vanadium surface) and zinc (zinc acetate, zinc citrate, zinc gluconate or zinc sulfate).

In certain embodiments, additives can include, but are not limited to, amino acids, peptides, and related molecules such as alanine, arginine, asparagine, aspartic acid, carnitine, citrulline, cysteine, cystine, dimethylglycine, gamma-aminobutyric acid, glutamic acid, glutamine, glutathione, glycine, histidine, isoleucine, leucine, lysine, methionine, ornithine, phenylalanine, proline, serine, taurine, threonine, tryptophan, tyrosine and valine.

In certain embodiments, additives can include, but are not limited to, animal extracts such as cod liver oil, marine lipids, shark cartilage, oyster shell, bee pollen and d-glucosamine sulfate. In certain embodiments, additives can include, but are not limited to, unsaturated free fatty acids such as .gamma.-linoleic, arachidonic and .alpha.-linolenic acid, which may be in an ester (e.g., ethyl ester or triglyceride) form.

In certain embodiments, additives can include, but are not limited to, herbs and plant extracts such as kelp, pectin, Spirulina, fiber, lecithin, wheat germ oil, safflower seed oil, flax seed, evening primrose, borage oil, blackcurrant, pumpkin seed oil, grape extract, grape seed extract, bark extract, pine bark extract, French maritime pine bark extract, muira puama extract, fennel seed extract, dong quai extract, chaste tree berry extract, alfalfa, saw palmetto berry extract, green tea extracts, angelica, catnip, cayenne, comfrey, garlic, ginger, ginseng, goldenseal, juniper berries, licorice, olive oil, parsley, peppermint, rosemary extract, valerian, white willow, yellow dock and yerba mate.

In certain embodiments, additives can include, but are not limited to, enzymes such as amylase, protease, lipase and papain as well as miscellaneous substances such as menaquinone, choline (choline bitartrate), inositol, carotenoids (beta-carotene, alpha-carotene, zeaxanthin, cryptoxanthin or lutein), para-aminobenzoic acid, betaine HCl, free omega-3 fatty acids and their esters, thiotic acid (alpha-lipoic acid), 1,2-dithiolane-3-pentanoic acid, 1,2-dithiolane-3-valeric acid, alkyl polyglycosides, polysorbate 80, sodium lauryl sulfate, flavanoids, flavanones, flavones, flavonols, isoflavones, proanthocyanidins, oligomeric proanthocyanidins, vitamin A aldehyde, a mixture of the components of vitamin A₂, the D Vitamins (D₁, D₂, D₃ and D₄) which can be treated as a mixture, ascorbyl palmitate and vitamin K₂.

In certain embodiments, fishmeal can be produced from treating fish bodies with a protease acting at a relatively low temperature. In certain embodiments, proteases that can be used include proteinases such as acrosin, urokinase, uropepsin, elastase, enteropeptidase, cathepsin, kallikrein, kininase 2, chymotrypsin, chymopapain, collagenase, streptokinase, subtilisin, thermolysin, trypsin, thrombin, papain, pancreatopeptidase and rennin; peptidases such as aminopeptidases, for example, arginine aminopeptidase, oxytocinase and leucine aminopeptidase; angiotensinase, angiotensin converting enzyme, insulinase, carboxypeptidase, for example, arginine carboxypeptidase, kininase 1 and thyroid peptidase, dipeptidases, for example, carnosinase and prolinase and pronases; as well as other proteases, denatured products thereof and compositions thereof.

Technical and scientific terms used herein have the meanings commonly understood by one of ordinary skill in the art to which the present systems and methods pertain, unless otherwise defined. Reference is made herein to various methodologies known to those of skill in the art. Publications and other materials setting forth such known methodologies to which reference is made are incorporated herein by reference in their entireties as though set forth in full. The practice of certain embodiments provided herein will employ, unless otherwise indicated, techniques of chemistry, biology, the aquaculture industry and the algae industry, which are within the skill of the art. Such techniques are explained fully in the literature, e.g., Aquaculture Engineering, Odd-Ivar Lekang, 2007, Blackwell Publishing Ltd.; Handbook of Microalgal Culture, edited by Amos Richmond, 2004, Blackwell Science; Microalgae Biotechnology and Microbiology, E.W. Becker, 1994, Cambridge University Press; Limnology: Lake and River Ecosystems, Robert G. Wetzel, 2001, Academic Press, each of which are incorporated by reference in their entireties.

All references cited herein are incorporated herein by reference in their entirety and for all purposes to the same extent as if each individual publication or patent or patent application was specifically and individually indicated to be incorporated by reference in its entirety for all purposes.

Many modifications and variations of the systems and methods provided herein can be made without departing from its spirit and scope, as will be apparent to those skilled in the art. The specific embodiments described herein are offered by way of example only, and are to be limited only by the terms of the appended claims along with the full scope of equivalents to which such claims are entitled.

What is claimed:

1. A method for producing biofuel from algae, said method comprising:
(i) providing an upwelled water in a body of water;
(ii) culturing algae in the upwelled water;
(iii) harvesting the algae by a population of planktivorous organisms that feed on the algae;
(iv) extracting lipids from the planktivorous organisms; and
(v) polishing the lipids to form biofuel.

2. The method of claim 1, wherein said step of providing an upwelled water comprises controlling a naturally occurring upwelling in said body of water.

3. The method of claim 2, wherein said step comprises manipulating density, salinity, temperature, or current of said body of water.

4. The method of claim 1, wherein said step of providing an upwelled water comprises generating upwelling in said body of water.

5. The method of claim 4, wherein said step comprises manipulating density, salinity, temperature, or current of said body of water.

6. The method of claim 1, wherein said step of providing an upwelled water further comprises adding micronutrients to said body of water.

7. The method of claim 1, wherein said population of planktivorous organisms are one or more populations of fishes.

8. The method of claim 1, wherein said step of harvesting algae comprises providing a cage that contains said population of planktivorous organisms.

9. The method of claim 1, further comprising extracting pigments from the planktivorous organisms.

10. A method for producing lipids from algae, said method comprising:
providing an upwelled water in a body of water;
(ii) culturing algae in the upwelled water;
(iii) harvesting the algae by a population of planktivorous organisms that feed on the algae;
(iv) extracting lipids from the planktivorous organisms; and
(v) processing lipids to form eicosapentaenoic acid (EPA) and/or docosahexaenoic acid (DHA) and/or derivatives thereof.

11. The method of claim 10, wherein said step of providing an upwelled water comprises controlling a naturally occurring upwelling in said body of water.

12. The method of claim 11, wherein said step comprises manipulating density, salinity, temperature, or current of said body of water.

13. The method of claim 10, wherein said step of providing an upwelled water comprises generating upwelling in said body of water.

14. The method of claim 13, wherein said step comprises manipulating density, salinity, temperature, or current of said body of water.

15. The method of claim 10, wherein said step of providing an upwelled water further comprises adding micronutrients to said body of water.

16. The method of claim 10, wherein said population of planktivorous organisms are one or more populations of fishes.

17. The method of claim 10, wherein said step of harvesting algae comprises providing a cage that contains said population of planktivorous organisms.

18. The method of claim 10, further comprising processing the lipids to form EPA- and/or DHA-containing products for human consumption or animal feeds.

19. The method of claim 10, wherein said extracting step comprises a processing technique selected from chromatography, fractional or molecular distillation, enzymatic splitting, low-temperature crystallization, supercritical fluid extraction, or urea complexation.

20. The method of claim 10, further comprising extracting pigments from the planktivorous organisms.

21. A system comprising a means for controlling an upwelling from a source to a target in a body of water, and at least one enclosure comprising a population of planktivorous organisms that feeds on algae and a population of algae, wherein said enclosure is located at said target in said body of water.

22. The system of claim 21, wherein said means for controlling an upwelling comprises means to regulate the rate, direction, or both the rate and direction, of fluid flow between said source and said enclosure located at said target in said body of water.

23. The system of claim 21, wherein said enclosure comprises means for feeding a controlled amount of said algae to said planktivorous organisms.

24. A system comprising a means for generating an upwelling from a source to a target in a body of water, and at least one enclosure comprising a population of planktivorous organisms that feeds on algae and a population of algae, wherein said enclosure is located at said target in said body of water.

25. The system of claim 24, wherein said means for controlling an upwelling comprises means to regulate the rate, direction, or both the rate and direction, of fluid flow between said source and said enclosure located at said target in said body of water.

26. The system of claim 24, wherein said enclosure comprises means for feeding a controlled amount of said algae to said planktivorous organisms.
